(19) United States
(12) Patent Application Publication
(10) Pub. No.: US 2009/0200796 A1
(43) Pub. Date: Aug. 13, 2009

(54) Quick-release coupling

(76) Inventor: Chien Fu Lai, Taichung (TW)

Correspondence Address: SAM CHEN, 7F-1, 293, ROOSEVELT ROAD, SEC 3, TAIPEI, TW

(21) Appl. No.: 12/028,986

(22) Filed: Feb. 11, 2008

(51) Int. Cl. F16L 39/04

(52) U.S. Cl. 285/317

(57) ABSTRACT

A quick-release coupling is provided and includes a male sub-assembly comprising a spring-biased first valve and two latches; and a female sub-assembly comprising a spring biased second valve and two hollow snapping members whereby snapping the latches through the snapping members will securely assemble the male and the female sub-assemblies together, thereby opening both valves to allow fluid to flow through.

### BACKGROUND OF THE INVENTION

1. Field of Invention

The invention relates to tube couplings and more particularly to a quick-release coupling with improved characteristics.

2. Description of Related Art

Tube couplings are well known in the art. For example, U.S. Pat. No. 5,775,742 discloses a tube coupling. Further, there are many types of quick-release/action coupling commercially available. Typically, a quick-release coupling must be capable of being installed quickly and reliably. However, such quick-release couplings have not been disclosed as far as the present inventor is aware. Thus, there is a need in the art for such quick-release coupling.

### SUMMARY OF THE INVENTION

It is therefore one object of the invention to provide a tube coupling comprising a male sub-assembly comprising a spring-biased first valve and two latches; and a female sub-assembly comprising a spring biased second valve and two hollow snapping members whereby snapping the latches through the snapping members will securely assemble the male and the female sub-assemblies together, thereby opening both valves to allow fluid to flow through.

The above and other objects, features and advantages of the invention will become apparent from the following detailed description taken with the accompanying drawings.

### BRIEF DESCRIPTION OF THE DRAWINGS

FIG. 1 is a perspective view of a tube coupling according to the invention;

FIG. 2 is an exploded perspective view of the tube coupling of FIG. 1;

FIG. 3 is an exploded view of the tube coupling of FIG. 1;

FIG. 4 is a longitudinal sectional view of the tube coupling of FIG. 2;

FIG. 5 is a side elevation of the tube coupling of FIG. 2 where the male sub-assembly is coupled to one tube and the female sub-assembly is coupled to the other tube;

FIG. 6 is a view similar to FIG. 5 where the male sub-assembly and the female sub-assembly are in the process of coupling together;

FIG. 7 is a sectional view taken along line A-A′ of FIG. 6;

FIG. 8 is a view similar to FIG. 6 where the male sub-assembly and the female sub-assembly are coupled together; and

FIG. 9 is a sectional view taken along line B-B′ of FIG. 8.

### DETAILED DESCRIPTION OF THE INVENTION

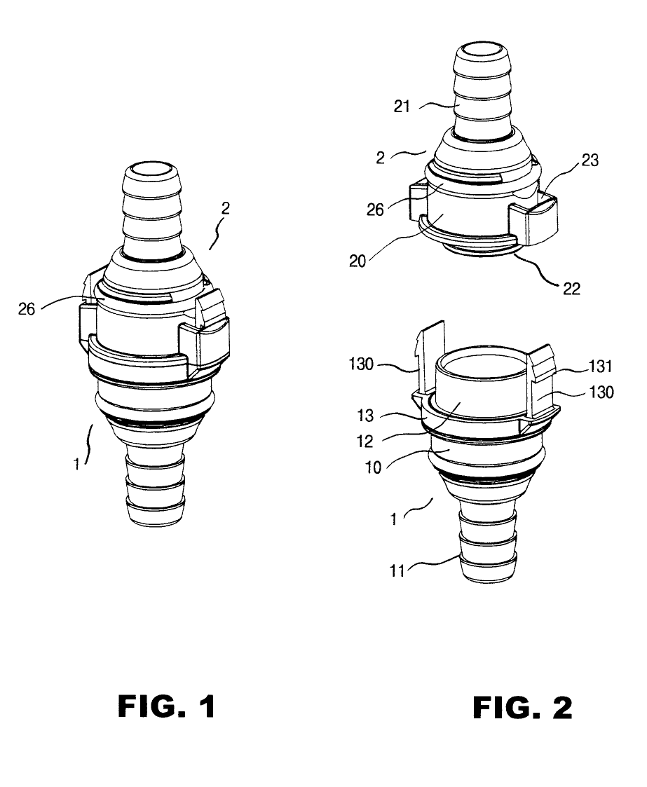

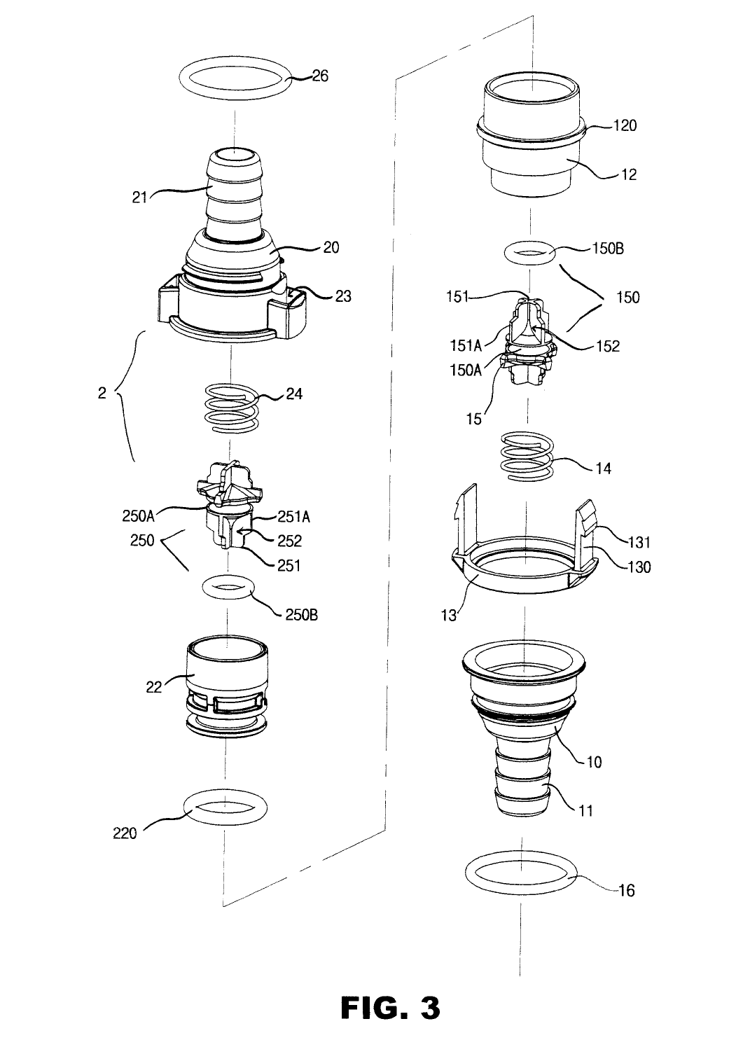

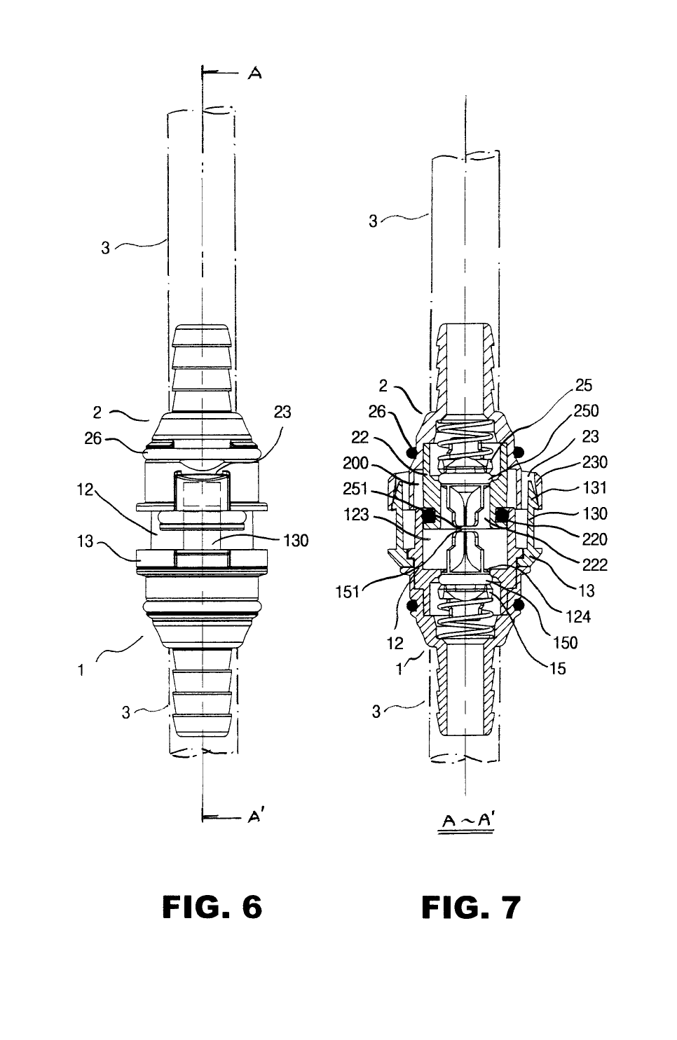

Referring to FIGS. 1 to 9, a quick-release/action type tube coupling in accordance with of the invention is illustrated. The tube coupling comprises a male sub-assembly 1 adapted to couple to one tube 3 and a female sub-assembly 2 adapted to couple to the other tube 3. Each component is discussed in detail below.

The male sub-assembly 1 comprises a tube connecting section 11 adapted to couple to one tube 3, a separate attaching section 12, and a gradually enlarged interconnecting section 10 integrally formed with the tube connecting section 11 to be coupled to the attaching section 12. The cylindrical attaching section 12 comprises an intermediate annular flange 120 on an outer surface, and an internal reduced bore member 121 for dividing an internal space of the attaching section 12 into an upper space 123 and a lower space 122. A torsion spring 14 is seated on one of three internal shoulders (not numbered) of the interconnecting section 10 at a joining portion of the interconnecting section 10 and the tube connecting section 11.

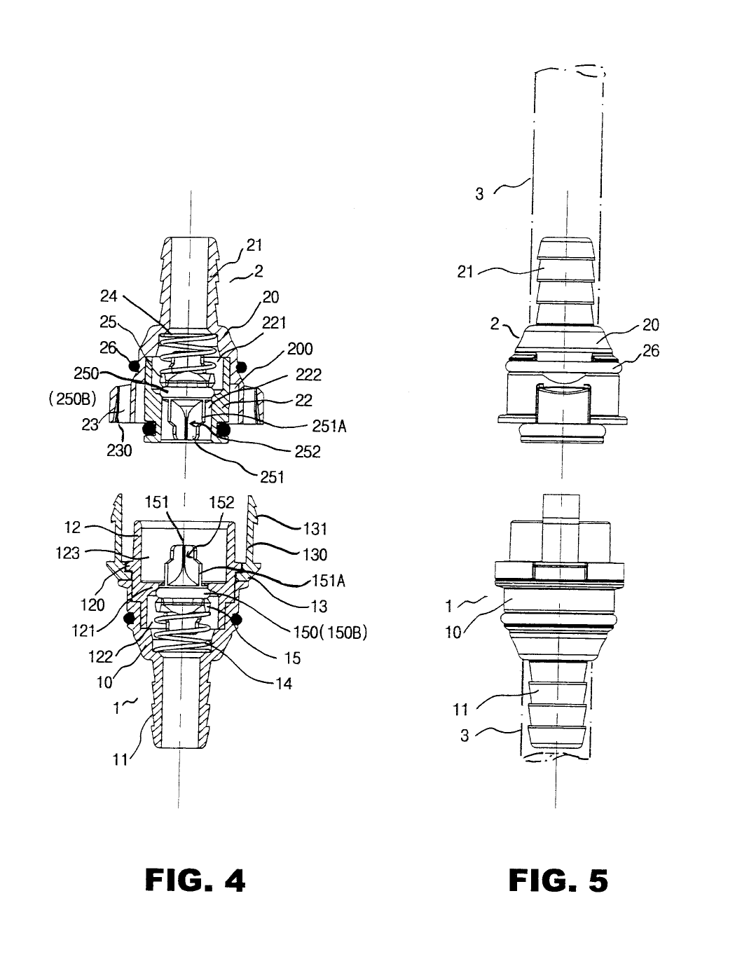

A first valve 15 comprises an upper urging member 151 having a plurality of (e.g., four) equally spaced wings 151A, a plurality of (e.g., four) gaps 152 each formed between two adjacent wings 151A, a lower urging member (not numbered) spaced from the upper urging member 151 and inserted into the spring 14 so that the first valve 15 can be resiliently supported by the spring 14, and an intermediate groove 150A between the upper urging member 151 and the lower urging member. An O-ring 150B made of rubber is put on the groove 150A. The groove 150A and the O-ring 150B consist of a sealing unit 150. The attaching section 12 has its lower staged portion matingly seated on the other two shoulders of the interconnecting section 10 with the reduced bore member 121 being sealingly engaged with the O-ring 150B (see FIG. 4). That is, the bore of the reduced bore member 121 is blocked for stopping any fluid flow.

A rubber O-ring 16 is put on an annular groove (not numbered) on an outer surface of the interconnecting section 10 to secure the interconnecting section 10 onto the lower portion of the attaching section 12. A ring-shaped flexible member 13 comprises two opposite upright latches 130 having a ridged end 131. The ring portion of the flexible member 13 is rotatably fastened between the flange 120 and the top annular flange (not numbered) of the interconnecting section 10 when the flexible member 13 is mounted.

The female sub-assembly 2 comprises a tube connecting section 21 adapted to couple to the other tube 3, a separate attaching section 22, and a gradually enlarged interconnecting section 20 integrally formed with the tube connecting section 21 to be coupled to the attaching section 22. The interconnecting section 20 has two opposite snapping members 23 on the lower portion. The hollow snapping member 23 has a longitudinal throughway 230 open to the top and the bottom ends thereof. A rubber O-ring 26 is put on an annular groove (not numbered) on an outer surface of the interconnecting section 20 just above the snapping members 23. The cylindrical attaching section 22 comprises a rubber O-ring 220 put on a lower annular groove (not numbered), and an internal shoulder (not numbered) for dividing an internal space of the attaching section 22 into an upper space 221 and a lower space 222.

A second valve 25 comprises a lower urging member 251 having a plurality of (e.g., four) equally spaced wings 251A, a plurality of (e.g., four) gaps 252 each formed between two adjacent wings 251A, an upper urging member (not numbered) spaced from the lower urging member 251 and being inserted into a torsion spring 24, and an intermediate groove 250A between the lower urging member 251 and the upper urging member. An O-ring 250B made of rubber is put on the groove 250A. The groove 250A and the O-ring 250B consist of a sealing unit 250. The attaching section 22 has its top urged against an intermediate internal shoulder of the interconnecting section 20. Also, the spring 24 has its top urged against a top internal shoulder of the interconnecting section 20 at a joining portion of the interconnecting section 20 and the tube connecting section 21, and its bottom urged against an enlarged seat (not numbered) of the upper urging member of the second valve 25 so that the internal shoulder of the attaching section 22 is sealingly engaged with the O-ring 250B (see FIG. 4). That is, the bore of the internal shoulder of the attaching section 22 is blocked for stopping any fluid flow.

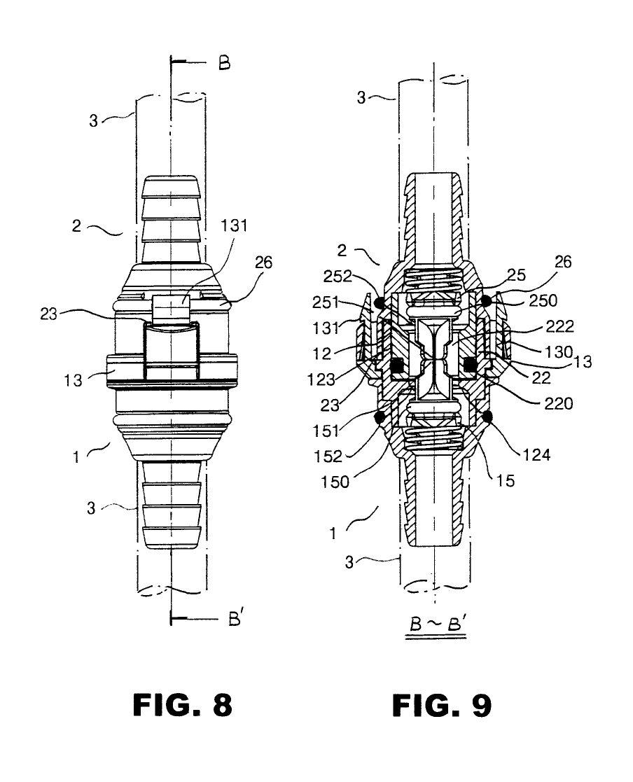

A person may align the female sub-assembly 2 with the male sub-assembly 1, i.e., aligning the throughways 230 of the snapping members 23 with the ridged ends 131 of the latches 130. Next, engage the female sub-assembly 2 with the male sub-assembly 1 by snapping the ridged ends 131 of the latches 130 through the throughways 230 of the snapping members 23 until the ridged ends 131 of the latches 130 suddenly expand outward due to the nature of its flexible material to secure to the tops of the throughways 230 after passing the tops of the throughways 230 of the snapping members 23. In the coupled state (see FIGS. 8 and 9), both springs 14, 24 are compressed. Also, a slight pressing of the ridged ends 131 of the latches 130 toward each other will not compromise the fastening of the latches 130 and the snapping members 23 due to the projecting O-ring 26. Further, the O-ring 220 seals other undesired flow paths in the coupling (i.e., leak being made impossible). Thus, fluid, for example, can flow from the lower tube 3 through the lower space 122, the gaps 152, the reduced bore member 121, the upper space 123, the lower space 222, the gaps 252, the bore of the internal shoulder of the attaching section 22, and the upper space 221 to the upper tube 3.

It is understood that a person may press the ridged ends 131 of the latches 130 toward each other with one hand until the ridged ends 131 of the latches 130 are not fastened with the snapping members 23. Next, for example, pull the male sub-assembly 1 downward to cause the ridged ends 131 of the latches 130 to clear the throughways 230 of the snapping members 23. As a result, the male sub-assembly 1 and the female sub-assembly 2 are disengaged.

In view of above, the coupling is capable of being either installed quickly and reliably or disengaged quickly.

While the invention herein disclosed has been described by means of specific embodiments, numerous modifications and variations could be made thereto by those skilled in the art without departing from the scope and spirit of the invention set forth in the claims.

What is claimed is:

1. A tube coupling comprising:
a male sub-assembly (1) comprising a first tube connecting section (11) coupled to a first section of a tube (3); a first attaching section (12) including an intermediate annular flange (120) on an outer surface thereof, and an internal reduced bore member (121) for dividing an internal space of the first attaching section (12) into a first space (122) and a second space (123) being in communication with the first space (122); a first interconnecting section (10) integrally formed with the first tube connecting section (11) with the first attaching section (12) anchored therein; a spring biased first valve (15) anchored in the first interconnecting section (10) and including a first urging member (151) having a plurality of equally spaced first wings (151A) with a first gap (152) formed between any two adjacent first wings (151A), and a first O-ring (150B) secured adjacent the first wings (151A) to block the reduced bore member (121); and a ring (13) including two opposite latches (130) oriented in a direction perpendicular to the ring (13), the ring (13) being adapted to rotatably fasten between the flange (120) and the top of the first interconnecting section (10); and
a female sub-assembly (2) comprising a second tube connecting section (21) coupled to a second section of the tube (3); a second attaching section (22) including a second O-ring (220), an internal third space (222), and an internal fourth space (221) being in communication with the third space (222); a second interconnecting section (20) integrally formed with the second tube connecting section (21) with the second attaching section (22) anchored therein, the second interconnecting section (20) including two opposite hollow snapping members (23); and a spring biased second valve (250) anchored in the second interconnecting section (20) and including a second urging member (251) having a plurality of equally spaced second wings (251A) with a second gap (252) formed between any two adjacent second wings (251A), and a third O-ring (25B) secured adjacent the second wings (251A) to block the communication between the fourth space (221) and the third space (222),
whereby snapping the latches (130) through the snapping members (23) will securely assemble the male sub-assembly (1) and the female sub-assembly (2) together so as to disengage the first O-ring (150B) from the reduced bore member (121) and move the third O-ring (25B) to stop blocking the communication between the fourth space (221) and the third space (222), thereby providing a flow path between the first section of the tube (3) and the second section of the tube (3) through the first, second, third, and fourth spaces (122, 123, 222, 221).

2. The tube coupling of claim 1, wherein the number of the first wings (151A) is four and the number of the second wings (251A) is four.
